(19) United States
(12) Patent Application Publication
(10) Pub. No.: US 2019/0195544 A1
(43) Pub. Date: Jun. 27, 2019

(54) PREPARATION SYSTEM FOR THE PREPARATION OF WHITE ICE

(71) Applicant: ECOCHROMA AG, Zurich (CH)

(72) Inventor: Jess RUGERIS, Weybridge (GB)

(73) Assignee: ECOCHROMA AG, Zurich (CH)

(21) Appl. No.: 16/151,173

(22) Filed: Oct. 3, 2018

Related U.S. Application Data
(63) Continuation of application No. 14/916,871, filed on Mar. 4, 2016, now abandoned.

(30) Foreign Application Priority Data
Sep. 5, 2013 (CH) 01524/13

(51) Int. Cl. F25C 1/18; C02F 1/02; F25C 1/12; C02F 1/32

(52) U.S. Cl. CPC F25C 1/18; C02F 1/02; F25B 6/02; C02F 1/325; F25C 1/12

(57) ABSTRACT

A unit for the preparation of cold, purified and carbonated water. The unit comprises a connection for a water supply; an optional sterilisation unit, e.g. in the form of a unit comprising at least one water inlet and at least one hot water outlet for discharging purified water. Further, there is a cooling unit comprising at least one hot water inlet and at least one cold water outlet; a carbonation unit comprising at least one inlet for introducing carbon dioxide into the cold, purified water so as to prepare cold, purified and carbonated water; and a water outlet for the delivery of the cold, purified and carbonated water from the pre-module to a freezing unit of an ice-making unit.

This is a Continuation of application Ser. No. 14/916,871 filed Mar. 4, 2016, claiming priority based on International Application No. PCT/EP2014/068257 filed Aug. 28, 2014, claiming priority based on Swiss Patent Application No. 01524/13 filed Sep. 5, 2013, the contents of all of which are incorporated herein by reference in their entirety.

### TECHNICAL FIELD

The present invention relates to a preparation system and a method for the preparation of white ice, in particular white purified ice.

### PRIOR ART

Ice cubes currently find wide application in the beverage industry, primarily for cooling beverages. Ice cubes are produced domestically by filling an ice cube tray with water and placing it in a freezer. Many domestic freezers are nowadays also equipped with an icemaker, which produces ice cubes automatically and stores them in a bin, from which they can be dispensed directly into a glass. Ice cubes are also produced commercially and sold in bulk; these ice cubes are often cylindrical and may also have recesses or holes through the centre. Examples of domestic and commercial ice cube machines are described in GB 1 498 205 and GB 2 387 896, for instance.

One problem of the commonly available ice-machines is their high energy consumption. For health reasons, the water used for the producing ice needs to be purified and cleaned, respectively, before the freezing process in order to avoid contamination of the beverages. This is generally achieved by heating the water to a temperature where at least most known pathogens are either killed or inactivated in a separate process and a separate unit before the water is used in a machine for the preparation of ice cubes. After the heating, the water needs to be cooled down again for the production of ice. Evidently, these heating and cooling processes consume a lot of energy, in particular when large amounts of water need to be decontaminated and cooled, respectively, and they need specific equipment which needs to be maintained and stored.

The energy consumption problem is aggravated by the fact that ice-machines generally carry out freezing cycles for batch-wise production of ice cubes. In a freezing cycle, a certain amount of water is transferred to a freezing unit, where cooling fingers are submerged in the water and cooled below 0° C., with the result that ice cubes form on these cooling fingers as the ice formation proceeds from the inside to the outside. When the ice thus formed has reached a defined thickness, the remaining non-frozen water is removed from the freezing means and is generally discharged. This means that much more water needs to be cleaned and cooled for each freezing cycle than the amount of water that ends up in the ice cubes. In fact, it was shown that generally only as little as 30%, in some cases up to 50%, of the water delivered to an ice machine is actually frozen to ice, which means that about 70% of the water is discharged, rendering these ice-machines highly inefficient. In addition to the mere cooling effect, ice cubes can also be produced in various colours and shapes in order to enhance the aesthetic properties. In this respect, WO 00/17589 describes a process for producing coloured ice cubes, wherein a colouring agent is added and mixed with pre-treated water, which is then frozen. When preparing coloured ice, it is usually difficult to obtain a uniform colouring. It is often the problem that coloured ice cubes used for cooling beverages also stain the beverage upon melting, which may lead to an unappetizing visual impression of the beverage.

### SUMMARY OF THE INVENTION

Considering the drawbacks in the state of the art, it is desirable to provide a preparation system that allows for an efficient and energetically friendly preparation of white and nutritionally safe ice.

It has now been found that it is possible energetically efficiently and constructively easily provide a combined unit which at the same time optionally sterilizes the supplied water and uses this sterilised water to produce safe ice cubes and which produces white ice cubes in an essentially continuous or quasi-continuous process.

It is thus an object of the present invention to provide a preparation system for a simple, energy-efficient, reliable and cost-effective preparation of white ice, which allows for the preparation of white ice, in a preferred embodiment of purified white ice, of consistently high quality.

The problem is solved by the unit as claimed and the methods as claimed. Further preferred embodiments are object of the dependent claims.

Correspondingly the present invention relates to a unit for the preparation of purified ice cubes. This unit comprises the following components:

a connection for a water supply;
an optional sterilisation unit, e.g. in the form of a heating unit with at least one water inlet connected to said water supply and at least one hot water outlet for discharging hot, purified water,
a cooling unit comprising at least one hot water inlet and at least one cold water outlet, at least one freezing unit for the making of the purified ice cubes having at least one water inlet connected to said cold water outlet, a water discharge outlet and an ice outlet.

One of the key elements of this unit is that said cooling unit and said freezing are separate units and that the unit further comprises a carbonation unit with at least one outlet for introducing carbon dioxide into the cold, purified water downstream of and/or in the cooling unit so as to prepare cold, purified and carbonated water upstream of the freezing unit.

Using this carbonation of the cold water surprisingly extremely white ice cubes can be generated essentially without any transparent regions. In addition to that the ice cubes have a lower density than conventional ice cubes due to the carbon dioxide in the ice cubes leading to a high porosity, which in turn leads to a smaller dilution of the corresponding beverage into which the ice cubes are immersed. Furthermore the ice cubes have a lower weight which is also advantageous for transportation aspects and water consumption aspects. Also depending on the degree of carbonation ice cubes can be tailored to either lead to a fizzy effect if added to a certain amount of liquid, or to only lead to a cooling effect if a lower carbon dioxide content is established in the cold water prior to freezing it. Precooling as well as carbonation and in particular the combination of the two furthermore leads to a significant increase of the ice production speed.

Said carbon dioxide is preferentially introduced into the cold water to lead to a carbon dioxide concentration the range of 0.05%-5 weight-%, preferably 0.1-2 weight-%, preferably at a temperature of the cold water in the range of less than 10° C., preferably 0.5-5° C., most preferably in the range of 3-4° C.

According to a preferred embodiment, it comprises a sterilisation unit. This can be either heating unit working with heat sterilisation, or it can be an electromagnetic irradiation sterilisation unit, which works with shortwave UV irradiation. These two methods can also be combined in one single element or in successive elements. In case of a heating unit this can be provided in the form of a, preferably continuous, flow-through heating unit controlled such that the water flowing through the unit is maintained at a temperature of at least 65° C. for a residence time span of at least 200 seconds within said unit. That was surprisingly found that it is possible to provide for such internal pasteurisation process of the supplied water in a continuous flow-through device still allowing for a high throughput and a fast and safe ice production and low energy consumption.

In case of electromagnetic irradiation sterilisation the water flowing through the unit is preferably exposed to UV radiation with a wavelength in the range of 300-100 nm, preferably with a dose in the range of at least 5 or 10, preferably at least 15 mWs/cm², preferably in the range of 15-50 mWs/cm², preferably in each case at 250-260 nm. Preferably for the irradiation mercury vapour ultraviolet lamps are used, preferably low pressure lamps. One of the advantages of using UV sterilisation is that the heat consumption is considerably lower than in case of heat sterilisation. A further advantage is that due to the fact that no heating takes place the risk of scale formation is substantially reduced. Furthermore it was found that at least partially the white appearance of the resulting ice cubes, in particular in case of addition of carbon dioxide, is influenced by minerals present in the water. If the content of these minerals is reduced due to the heating and scale formation there is also a risk of a lower white appearance of the resulting ice cubes.

According to a preferred embodiment of the proposed unit, said sterilisation unit if operated as heating unit is controlled such that the water flowing through the unit is maintained at a temperature of at least 70° C., preferably at least 85° C., more preferably at least 95° C., and most preferably at least 98° C. Also possible is steam pasteurisation so to have water at a temperature of at least 110° C. All these values are given for a residence time span of at least 60 seconds, preferably at least 15 seconds, more preferably at least 5 seconds, and most preferably at least 2 seconds within said unit.

The purified water downstream of said sterilisation unit, if operated as heating unit can, according to yet another preferred embodiment, be used to at least partially preheat the water supply of the heating unit. This pre-heating can be carried out in a counter flow direction, for example in that the water inlet supply tube of the heating unit is surrounded by a larger diameter hollow body, preferably in the form of a cocentrical cylindrical structure, in the inter space of which the heart, purified water downstream of said heating unit circulates counter to the flow in the supply tube prior to entering the cooling unit.

In the alternative or in addition to the above-mentioned counter flow preheating it is possible that the cooling unit and the heating unit are connected to a heating/cooling circuit, said heating/cooling circuit involving a circulation fluid, which circulates between the cooling unit and the heating unit through heat exchangers for transferring heat from the cooling unit to the heating unit.

Said cooling unit and said freezing unit can also be combined in one cooling/freezing unit. The unit may, according to yet another preferred embodiment, further comprise a water storage unit for storing discharged water from the freezing unit, wherein preferably the water storage unit may comprises a water storage outlet, which is connected to the water inlet of the freezing unit for re-introducing the stored cold, purified and carbonated water into the freezing unit of the ice-making unit.

The freezing unit may include at least one freezing element, which can preferably be in form of one or more cooling fingers and/or moulds and/or a lattice or an ice extruder, wherein preferably the at least one freezing element can be cooled for producing ice and heated for discharging the ice from the freezing element.

The freezing unit may further comprise at least one spraying nozzle for spraying the cold, purified and carbonated water onto the freezing element, and preferably also an intermittent valve, which is intended for interrupting the delivery of cold, purified and carbonated water to the spraying nozzle at predefined time intervals. In case of carbonization the spraying can even be achieved just due to the pressure of this carbonization process are no additional pump is necessary. For achieving optimum whiteness of the ice cubes according to a preferred embodiment it is possible after release of formed ice cubes from the freezing elements to cool them down to at least 0° C. or below 0° C. before spraying of pre-cold water onto the freezing elements again.

In order to reduce the complexity and size of the unit, at least the outlet of the carbonation unit can be incorporated into the cooling unit such that the carbon dioxide is introduced into the purified water previously cooled in the cooling unit. Alternatively, the carbonation unit may also be provided as a separate unit.

Due to the use of a single, central internal heating unit, purification and disinfection of the water is efficiently accomplished before the water is transferred to a next component of the unit of the present invention. The water supplied to the unit may therefore be from a general cold water supply, such as a public water supply, which allows for the installation of the unit in most public or private premises. Thanks to the purification of the water in the heating unit before further processing, additional cleaning costs for cleaning the subsequent components (e.g. the cooling or the carbonation unit) can also be avoided.

The hot water from the heating unit can further be used for cleaning the unit and/or the ice-making unit, by flushing the components of the unit and/or the ice-making unit with hot, purified water. For instance, by switching off the cooling unit and the carbonation unit, hot, purified water can be prepared and pumped from the heating unit to all other components of the unit and/or the ice-making unit for cleaning them.

The term “ice cubes”, as used throughout this application, refers to pieces of ice in any size and any shape. Thus, not only pieces of ice in cubic shape are encompassed but also ice units of cylindrical, round or irregular cross-section.

For energy saving reasons, is preferred that heat set free during the cooling process of the water is used for heating the water in the heating unit. This heat transfer between water to be cooled and water to be heated can be accomplished by a heating/cooling circuit provided in the unit. Such a heating/cooling circuit generally may involve a circulation fluid, which circulates between the cooling unit and the heating unit. In the heating and cooling unit, respectively, the circulation fluid is fed through heat exchangers, for transferring heat from the cooling unit to the heating unit. Thus, heat withdrawn from the hot, purified water to be cooled in the cooling unit is used for heating the water in the heating unit. That way, the energy consumption for heating and cooling, respectively, can be substantially reduced.

In a preferred embodiment, the heat exchangers are designed to maximize the surface area of a wall between a cold medium (e.g. circulation fluid) and a hot medium (e.g. hot water from the heating unit) in order to enhance their efficiency. The circulation fluid is thus preferably not in direct contact with the water to be heated or cooled, but heat energy transfer is accomplished indirectly via a common wall in the heat exchangers.

For storing the water in its individual components, the unit of the present invention may comprise a number of storing units, such as water tanks, for instance. Such storage units are preferably well insulated to avoid heat transfer from/to the surroundings, and may also be cooled or heated. That way, water can be stored at optimal temperature conditions before or after a respective processing step. For instance, the heating unit may comprise a heating tank and/or the cooling unit may comprise a cooling tank. If the carbonation unit is provided as a separate unit from the cooling unit, the carbonation unit may also comprise a water storage unit, e.g. a water tank. In order to enable energy saving during heating and cooling processes, all water storage units are preferably well insulated. In case of at least two water storage units, e.g. a heating and a cooling tank, they may have a common wall, which is preferably well insulated as well.

In addition, the unit of the present invention may also comprise one or more sensors, for example a flow rate sensor for measuring the amount of water transferred from one component to another, a temperature sensor or a filling level meter for determining the filling level of the water in the heating unit, the cooling unit, the carbonation unit, and the water storage unit, for instance.

In a particularly preferred embodiment, the unit of the present invention further comprises a control unit, which preferably comprises a microprocessor. The control unit is used for controlling at least one component selected from the group consisting of the water supply, the heating unit, the cooling unit, the carbonation unit, and preferably also the ice-making unit, and, if applicable, also the heating/cooling circuit, the one or more water pumps and the one or more valves. In particular, the control unit can be used for controlling the amount of water supplied from one component to another by opening or closing valves assigned to respective water in- or outlets, or by regulating the water pumps. The control unit may also be used for controlling the addition rate and/or the amount of carbon dioxide added to the cold, purified water. The control unit is preferably operable via wireless data transfer.

It is further preferred that the unit of the present invention comprises a water filter, which is preferably arranged between the connection for the water supply and the heating unit. The water filter allows for an additional purification of the water supplied to the unit.

In addition, the unit of the present invention preferably further comprises a housing, in particular a housing, a connection for power supply and a control panel of the control unit. It is thereby preferred that the housing encloses at least some of the components of the unit, preferably all of them, in order to facilitate transportation and to guarantee that the preparation takes place under hygienic conditions by shielding the products during their preparation from the surroundings, thus avoiding contamination.

The unit of the present invention thus allows for an efficient and energy saving preparation of cold, purified and optionally carbonated water, from which purified white ice can be prepared.

Due to the carbon dioxide contained in the water, the purified white ice prepared according to the present invention has the advantage of melting more slowly and of adding less water to a drink upon melting than normal ice prepared from non-carbonated water. Thereby, excessive dilution of the drink is avoided.

Owing to the gas bubbles enclosed in the ice, the purified white ice cubes prepared according to the present invention are lighter in weight than conventional ice cubes and enable a faster cooling of the drink due to the enlarged surface of the purified, white ice cubes compared to ice cubes of conventional clear ice.

Furthermore, the unit of the present invention also allows for the preparation of purified white ice, which has a different melting behaviour compared to normal ice conventionally used for cooling beverages. In particular, depending on the amount of carbon dioxide added to the water, purified white ice with different melting effects can be produced.

The carbon dioxide is generally fed into the purified and cooled water at a pressure of around 1-5 bar until the carbon dioxide concentration in the water is e.g. between 1 and 4 g/l, whereby the carbon dioxide concentration in the water may also vary depending on the water temperature. If the concentration of the carbon dioxide is above 3 or 4 g/l (above 0.3 or 0.4 weight-%), purified white ice with a special “fizzing effect” is obtained upon freezing. Such ice cubes will bubble and fizz when added to a drink, even after several months of storage in a freezer. Especially when using these ice cubes in carbonated drinks, the fizzing and bubbling effect of the drink is intensified and will slow down the process of the drink losing its carbon dioxide content. On the other hand, if the carbon dioxide concentration is kept between about 0.5 to 2 g/l, preferably in the range of 1 to 1.5 g/l (0.05-0.2% by weight, preferably 0.1-0.15% by weight), white ice is produced that does not fizz or bubble upon melting of the ice in a liquid, e.g. a drink. Such purified white ice cubes are particularly preferred when added to non-carbonated drinks, such as liquors or whiskey, for instance.

As mentioned above, by cooling the purified water prior to its carbonation, the amount of carbon dioxide that can be dissolved in the water is significantly enhanced. The water is preferably cooled below 10° C., more preferably below 5° C., most preferably to a temperature of 0.5° C. to 4° C. When such cold, purified and carbonated water is fed to an ice-making unit according to the ice preparation system of the present invention, an extremely prominent and uniform white colouring of the ice is obtained. Also, by cooling the water centrally in the cooling unit before the actual freezing process in the ice-making unit, the energy needed by the freezing unit is minimized, as well as the freezing time.

Thanks to fact that the water supplied to the ice-making unit is centrally heated in the heating unit prior to the cooling and carbonating process, it is possible to use unprocessed water for the preparation of purified white ice in the ice-making unit of the ice preparation system of the present invention.

Preferably, the ice-making unit of the present invention comprises at least one ice storage unit for storing ice until the moment it is used. The ice storage unit is preferably in form of a container which is accommodated within the freezing unit itself in a manner that the finished pieces of ice can drop into the ice storage unit without any manual contact. Alternatively, the ice storage unit may also be arranged outside the freezing unit and connected to an ice outlet, e.g. a flap door, of the freezing unit. It is further preferred that the ice storage unit is designed as a drawer, with the result that it can be drawn out of the housing of the ice-making unit, together with its contents, in order to allow removal. It is also possible that the ice, in particular when in form of ice cubes, is directly supplied to a packaging unit (not shown) and packaged for sale, for instance in plastic bags.

In order to avoid melting of the ice stored therein, the ice storage unit can be cooled to below 0° C., preferably below −5° C. In the case of a particularly compact construction, the freezing unit preferably comprises a single container which serves as a freezing tank and also as an ice storage container for finished pieces of ice. In this case, the ice storage unit forms a part of the freezing unit itself.

The unit may further comprise one or more water storage unit for storing cold, purified and carbonated water discharged from the freezing unit. Such a water storage unit preferably comprises a water storage inlet connected to the water discharge outlet of the freezing unit and a water storage outlet which is directly or indirectly connected to the water inlet of the freezing unit for re-introducing cold, purified and carbonated water into the freezing unit of the ice-making unit.

For energy saving purposes, the water storage unit is preferably small and well insulated to prevent heat transfer from its surroundings to the water. Since the ice-preparation system of the present invention offers the option of preparing only as much cold, purified and carbonated water that is actually needed during one freezing cycle, there is no need for providing large water storage unit. Instead of a water tank, the water storage unit may actually also merely be in form of a water pipe—e.g. in serpentine shape—that allows for storing a certain amount of water and connects the water discharge outlet of the freezing unit with the water inlet of the latter.

It is further preferred that the freezing unit of the ice-making unit comprises at least one freezing element, preferably an array of two or more freezing elements, which can be cooled for producing the ice and heated for discharging the ice from the freezing element(s).

The at least one freezing element is preferably in form of cooling fingers and/or moulds and/or a lattice or an ice extruder.

The at least one freezing element usually comprises a metal outer surface and may be in any desired cross-section. For preparing e.g. ice cubes with a circular cross section, a freezing element with circular cross section is used. But also freezing elements with other cross section shapes are possible, such as triangle, oval, square, heart or star shaped cross-sections, for instance.

In this regard, the at least one freezing element is most preferably in the form of one or more cooling fingers. These cooling fingers can either be immersed in the cold, purified and carbonated water or the cold, purified and carbonated water can be sprayed thereon for producing purified white ice by cooling the at least one cooling finger below 0° C., preferably below −20° C. Typically, each finger has an essentially cylindrical cross-section and a downwardly tapering, conical surface. Upon cooling the cooling fingers, water contacting the surface of the fingers will freeze and adhere to the surface. Thus, ice will build up gradually around the cooling fingers. The size of the ice is determined by the time period, during which the freezing element is cooled. A sensor may be used for measuring the size of the ice formed in the freezing unit.

When immersing the cooling fingers in the cold, purified and carbonated water, the freezing unit preferably comprises a freezing tank which is filled with the cold, purified and carbonated water. As soon as the purified white ice built up around the cooling fingers has reached the desired size or thickness, the remaining water is removed from the freezing unit and is preferably transferred to the water storage unit. From the storage unit, the stored water is preferably re-introduced into the freezing unit. Upon slight heating of the cooling fingers, the ice disengages from their surface and drops into the emptied freezing tank from where it can be transferred to an ice storage unit.

For cooling and heating the freezing element, a conventional refrigeration circuit can be used. With regard to the production of ice using a freezing element in the form of cooling fingers that are immersed in water, it is referred to GB 1 498 205, in which such a production method is described in detail and the disclosure of which is herewith incorporated by reference. As concerns the refrigeration circuit, in particular the one for the freezing unit, surprisingly it was found that low temperature compressors, namely below −20° C. compressors, specifically compressors in the range of (−35)-(−25)° C., and in particular −30° C. compressors as opposed to the −20° C. compressors conventionally used in icemaking machines, lead to the fastest and still energy-saving icemaking process. These low temperature compressors are conventionally avoided since they lead to undesired milky ice, while in the present context where white ice is to be produced, such a low temperature compressor has significant advantages.

Instead of immersing the cooling fingers in the cold, purified and carbonated water, the latter may also be sprayed onto the cooling fingers for the production of purified white ice. For this purpose, the freezing unit further comprises at least one spraying nozzle for spraying the cold, purified and carbonated water onto the freezing element, and an intermittent valve. Said intermittent valve is intended for periodically interrupting the delivery of cold, purified and carbonated water to the spraying nozzle at predefined time intervals. As will be explained in more detail further below, this embodiment of the ice-preparation system of the present invention is particularly preferred as it not only allows for the production of extremely pure and astonishingly white-looking ice, but also to use up to 100% of the water delivered to the freezing unit.

It is further preferred that the at least one freezing element is in the form of at least one mould or lattice. For the preparation of purified white ice, the at least one mould or lattice is filled with the cold, purified and carbonated water and subsequently cooled in the freezing unit below 0° C. For extracting the ice from the mould or lattice, the mould or lattice may be slightly heated for disengaging the ice from the inner surface of the mould and lattice, respectively.

Alternatively, freezing elements of other forms may also be used, i.e. an ice extruder. The freezing unit preferably further comprises at least one freezing chamber and may also comprise at least one separate water storage unit for accumulating and storing a certain amount of cold, purified and carbonated water in the freezing unit for the preparation of purified white ice in the freezing chamber. It is thereby possible that the freezing chamber is either connected to the water storage unit or that the water storage unit is arranged within the freezing chamber, e.g. in form of a freezing tank.

In the ice preparation system of the present invention, the freezing unit of the ice-making unit may not only be supplied with cold, purified and carbonated water but also with cold, purified and non-carbonated—meaning clear—water. Therefore, the ice preparation system of the present invention also allows for sequential preparation of white and clear ice. For instance, bi- or multi-layered ice cubes with layers of white and clear ice may be prepared, as will be described in more detail below.

For preparing bi- or multi-layered ice cubes, the ice-making unit preferably comprises a first water storage unit for the cold, purified and carbonated water and a second water storage unit for the cold, purified, clear water. This allows for storing the cold, purified and carbonated water and the cold, purified and clear water separately between two freezing cycles. For instance, the freezing unit may comprise a freezing chamber, which is connected to both water storage unit. This embodiment is particularly preferred for the production of bi-layered ice from cold, purified, clear water and cold, purified, carbonated water, respectively.

However, bi- or multi-layered ice cubes can also be prepared without requiring any storage unit as the ice-preparation system of the present invention allows for preparing just the amount of cold, purified and carbonated or non-carbonated that is required at the time. For instance, a predetermined amount of cold, purified and carbonated water can be prepared in the carbonation unit and transferred to the freezing unit. Then, the carbonation unit is switched off and cold, purified and non-carbonated water can be prepared in the cooling unit and supplied to the freezing unit without being carbonated in the freezing unit. In between, there is thus no need for storing any water before being transferred to the freezing unit of the ice-making unit.

Preferably, the ice-making unit of the present invention further comprises a hands free dispenser system, such that the ice can be dispensed and packaged automatically without human contact to avoid contamination of the ice. The ice can thereby be packaged in bags, for instance.

Furthermore the present invention relates to a method for preparing purified ice, preferably using a unit as outlined above. According to this method, preferably upstream of at least one freezing unit for the making of the purified ice cubes the supplied water is cooled in a a cooling unit and a carbonation unit is provided comprising at least one outlet introducing carbon dioxide into the cold, purified water downstream of and/or in the cooling unit so as to prepare cold, purified and carbonated water upstream of the freezing unit to lead to white ice cubes.

As also outlined above, carbon dioxide can be introduced into the cold purified water to lead to a carbon dioxide concentration the range of 0.05%-5 weight-%, preferably 0.1-2 weight-%, preferably at a temperature of the cold water in the range of 0.5-5° C., most preferably in the range of 3-4° C. This to obtain highly white ice cubes, which, depending on the degree of carbonation, are either leading to fizzy effects in the liquid if added to said liquid, or without leading to fizzy effects.

According to a preferred embodiment of this method, the water upstream of said cooling unit can be treated in a sterilisation unit, which can be a heat sterilisation unit and/or an electromagnetic irradiation sterilisation unit integrated in the same unit. The sterilisation unit can be a continuous flow-through unit or it can be an intermittent flow-through unit. If heat sterilisation is used, it is heated in a heating unit integrated in the same unit, and wherein said heating unit is a, preferably continuous or quasi-continuous flow-through, heating unit controlled such that the water flowing through the unit is maintained at a temperature of at least 65° C. for a residence time span of at least 200 seconds within said unit. In case of electromagnetic irradiation sterilisation the water flowing through the unit is exposed to UV radiation with a wavelength in the range of 300-100 nm, preferably with a dose in the range of at least 5 or 10, preferably at least 15 mWs/cm², preferably in the range of 15-50 mWs/cm², preferably in each case at 250-260 nm, and wherein preferably for the irradiation mercury vapour ultraviolet lamps are used, preferably low pressure lamps.

Preferentially, heating unit is controlled such that the water flowing through the unit is maintained at a temperature of at least 70° C., preferably at least 85° C., more preferably at least 95° C., and most preferably at least 98° C. or at least 110° C. for a residence time span of at least 60 seconds, preferably at least 15 seconds, more preferably at least 5 seconds, and most preferably at least 2 seconds within said unit.

Furthermore, the purified white ice may also be prepared with different degrees of porosity by adjusting the amount of carbon dioxide introduced into the cold, purified water and/or by using different ways to bring the cooling element in contact with the cold, purified and carbonated water.

A further important benefit arises from the inventive combination of the spray-freezing technology with the use of an intermittent valve for interrupting the water delivery to the spraying nozzles at predefined time intervals.

It has been found to be particularly advantageous if the cold, purified water to be sprayed onto the freezing element has a temperature just above freezing point, as this allows the water to freeze and stick to the freezing element almost immediately.

It has now been found a way to make use of this effect for making the method particularly economically and environmentally favourable: A predefined amount of cold, purified and carbonated water is sprayed onto the cooled cooling fingers before the water supply is interrupted by the intermittent valve. Said predefined amount of water is adjusted such that essentially all water sprayed onto the cooling fingers adheres to the surface of the latter and freezes instantly. Purified white ice cubes are thus prepared by forming multiple layers of purified white ice on top of each other until ice of a predefined thickness has formed on the freezing element. Thus, essentially all cold, purified and carbonated water is frozen to purified white ice and essentially no water will have to be discharged from and/or reintroduced into the freezing unit.

For the purpose of further energy saving, cold, purified and carbonated water is preferably delivered directly to the freezing unit and thus to the spraying unit without intermediate storing.

It was surprisingly found that despite interrupting the spraying process, the ice formation process was much faster: In fact, when using the spraying technology, the time for producing a batch of ice-cubes of a predefined size by the method of the present invention could be reduced by up to 50% compared to the time needed when using cooling fingers that are immersed in the cold, purified and carbonated water, for instance.

This makes the use of the spray-freezing technology by the method of the present invention also particularly beneficial for the preparation of bi-layered ice cubes, as the fast freezing process not only allows for better adherence of a newly formed layer to the previous layer but also leads to very sharp transitions between the two layers.

For the production of bi-layered ice, cold, purified and carbonated water is delivered to the spraying unit and sprayed onto the freezing element until a layer of purified white ice of a predefined thickness has formed on the freezing element. Then, delivery of cold, purified and carbonated water to the spraying unit is stopped and cold, purified and non-carbonated water is delivered to the spraying unit instead. The cold, purified and non-carbonated water is thus sprayed onto the freezing element until a predefined thickness of clear ice has formed. Then, again, the delivery of cold, purified and non-carbonated water to the spraying unit is stopped and the freezing element is subsequently heated to discharge the bi-layered ice from the freezing element. It goes without saying that the above order of first preparing white ice and then providing clear ice on top of the white ice can be freely exchanged. Thus, it is possible to prepare ice cubes having a core of clear ice and a layer of white ice formed around the core. Of course, the core and/or the outer layer may also have a special shape, such that an ice cube with a logo is formed.

In line with the above, multi-layered ice can be prepared by producing several layers of white and clear ice, respectively, before discharging the ice from the freezing element.

For the preparation of bi- or multi-layered ice, the spraying unit preferably comprises at least two spraying nozzles such that cold, purified and carbonated water can be sprayed onto the freezing element by a first spraying nozzle, and cold, purified and non-carbonated water can be sprayed by means of a second spraying nozzle.

The concept of using the spray-freezing technology in combination with an intermittent valve for continuously interrupting the water delivery to the spraying nozzle at predefined time intervals according to the present invention is considered inventive in its own right, as it allows for a batch-wise production of ice that is not only much faster but also much more energy-efficient than other ice preparation systems known in the state of the art. In order to avoid the formation of clear ice it can be advantageous to adapt the water supply to the freezing elements such that essentially running of the water on the freezing elements is prevented. As mentioned above, thanks to the concept, the time for preparing one batch of ice cubes could be reduced by 50% compared to when a different freezing method was used.

Therefore, in another aspect, the present invention provides a method for a fast and straight-forward preparation of ice cubes. Said method comprises the steps of

a) providing an ice-machine comprising a freezing unit, said freezing unit comprising at least one freezing element, which can be cooled for producing ice and heated for discharging the ice from the freezing element, and further comprising at least one spraying nozzle and an intermittent valve,
b) supplying cold water to the at least one nozzle,
c) spraying the cold water onto the cooled freezing element to produce ice, while periodically interrupting the supply of the cold water to the at least one spraying nozzle by means of the intermittent valve at predefined time intervals during the freezing process. The freezing element preferably comprises vertically oriented fingers of a heat conductive material, which are spaced apart from each other. The cold, purified water is sprayed onto the fingers, which are cooled below 0° C., preferably below −10° C., more preferably below −20° C., such that the cold, purified water freezes and adheres to the surface of the fingers. Upon heating the fingers, the ice at the interface of each ice cube and the surface of the fingers will melt and the ice cubes will drop from the latter due to gravitational force.

The ice prepared in accordance with this method is produced in batches. With regard to further details of the production of the ice, it is referred to the detailed description given above for the production of purified white ice.

The above-described method of the present invention is preferably intended for the production of purified white ice. However, also purified and coloured or clear ice, in particular ice cubes, can be prepared by the method of the present invention.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic view of a preferred embodiment of the ice-preparation system of the present invention.

### DESCRIPTION OF PREFERRED EMBODIMENTS

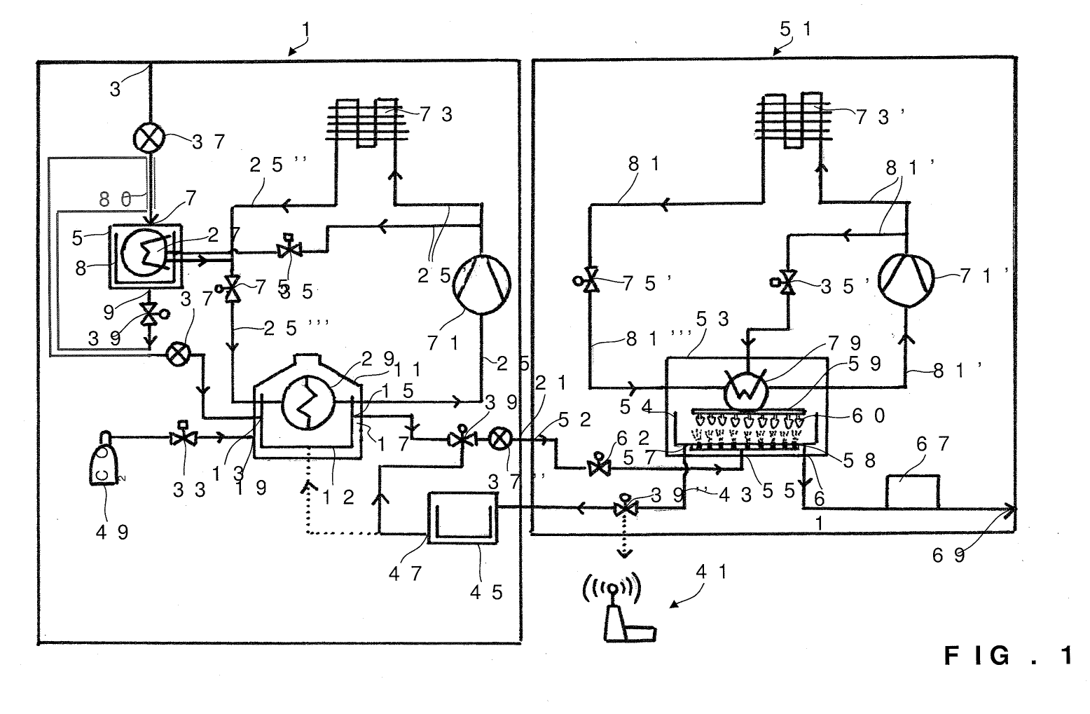

The ice-preparation unit shown in FIG. 1 comprises a pre-module 1 and an ice-making unit 51. The pre-module 1 comprises a connection for an external water supply 3, a heating unit 5, a cooling unit 11, a carbonation unit 17, and a water outlet 21 for the delivery of water from the pre-module 1 to a freezing unit 53 of an ice-making unit 51.

The heating unit 5 comprises a heating tank 8 with a water inlet 7, which is connected to the water supply 3 for feeding the heating unit 5 with water, and a hot water outlet 9 for discharging hot, purified water. The cooling unit 11 comprises a cooling tank 12 and a hot water inlet 13, which is connected to the hot water outlet 9 for feeding the cooling unit 11 with hot, purified water, and further comprises a cold water outlet 15. The carbonation unit 17 is contained within the cooling unit 11 and comprises at least one outlet 19 for introducing carbon dioxide into the cold, purified water so as to prepare cold, purified and carbonated water. The cold water outlet 15 is connected to the water outlet 21 of the pre-module 1 for the delivery of the cold, purified and carbonated water from the pre-module 1 to the ice-making unit 51.

The hot, purified water discharged from the heating unit 5 is thus delivered to the cooling unit 11 into the cooling tank 12 which includes a water level sensor (not shown) controlled by a micro-processor in a control unit 41 for sensing and controlling the water level in the cooling tank 12. The control unit 41 also controls a first valve 39 for cutting off water supply from the heating unit 5 to the cooling unit 11 according to a sensing signal when a predetermined amount of water has been introduced into the cooling tank 12 of the cooling unit 11.

The pre-module 1 further comprises a heating/cooling circuit, preferably a Clausius-Rankine cycle, which is a vapour-compression refrigeration process and is described in DE 102 59 488 A1, for instance.

The heating/cooling circuit comprises a compressor 71, a condenser 73, a throttle valve 75 and two heat exchangers 27, 29, and uses a circulation fluid 25, 25′, 25″, 25′″, which circulates between the cooling unit 11, the heating unit 5 and the heat exchangers 27, 29 for transferring heat from the cooling unit 11 to the heating unit 5.

The circulation fluid 25 enters the compressor 71 and is compressed to a higher pressure, resulting in a higher temperature as well. The hot, compressed circulation fluid 25′ is then in the thermodynamic state known as a hot vapour and it is at a temperature and pressure at which it can be condensed with a cooling media such as cold water or air.

Part of the hot vapour 25′ is fed in an auxiliary-circuit which is routed through the heat exchanger 27 in the heating unit 5 for transferring heat from the hot vapour 25′ to the water to be heated up in the heating unit 5.

Normally the main part of the hot vapour 25′ is routed through the condenser 73 where it is cooled and condensed into liquid circulation fluid 25″ by flowing through coils or tubes, which are in contact with a cooling media, e.g. cold water or cold air.

The condensed liquid circulation fluid 25″, in the thermodynamic state known as a saturated liquid, is next routed through the throttle valve 75 where it undergoes an abrupt reduction in pressure. That pressure reduction results in the adiabatic flash evaporation of a part of the liquid circulation fluid 25″. The auto-refrigeration effect of the adiabatic flash evaporation lowers the temperature of the circulation fluid 25″ to a temperature which is colder than the temperature of the water in the cooling unit 11. The cold circulation fluid 25′″ is then routed through coils or tubes of the heat exchanger 29 in the cooling unit 11. Said coils or tubes are in direct or indirect contact with the purified water in the cooling tank 12 of the cooling unit 11. The cold circulation fluid 25′″ in the heat exchanger 29 absorbs and removes heat from the hot, purified water delivered to the cooling unit 11 in order to cool the purified water to a preferred temperature of about 0.5 to 4° C. To complete the heating/cooling circuit cycle, the circulation fluid 25, after having taken up the heat from the purified water to be cooled in the cooling tank 12, is routed back to the compressor 71.

Thus, by the above described heating/cooling circuit, the temperature of the purified water delivered to the cooling tank 12 is gradually lowered until it reaches the value set by a temperature sensor mounted inside the cooling tank 12 (not shown). At this point, preferably at 0.5 to 4° C., carbon dioxide is introduced into the cold, purified water in order to obtain cold, purified and carbonated water. The process can be carried out batch-wise, or it can be carried out continuously, i.e. there is continuous supply of water to the heating unit 5, this unit 5 delivers a continuous flow of heated pasteurised water, and the cooling unit 11 continuously cools this water, i.e. in the tank 12 of the temperature is regulated to be in the range of 0.5 to 5° C. preferably in the range of 3-4° C., and continuously the carbonation takes place in the unit 11. Correspondingly therefore there is also continuous supply of clean cold water by the unit 11 to the unit 53. The carbon dioxide is stored in a carbon dioxide supply tank 49 under pressure. The carbon dioxide supply tank 49 is connected to the outlet 19 for introducing the carbon dioxide into the cold, purified water. The amount of carbon dioxide supplied from the supply tank 49 is regulated by a dosage valve 33.

Preferably if carbonation takes place the carbon dioxide is introduced into the cold liquid in unit 11 at a CO₂ pressure of 3.4 bar. This pressure can however also be lower. In order to obtain white ice cubes, the concentration of carbon dioxide in the cold water should be elevated from the natural level of around 10 ppm (which is equivalent to 0.0001%) to a value in the range of 0.05%-5%, preferably 0.1-2% (percentages always by weight), at a temperature in the preferred range of 0.5-5° C., preferably in the range of 3-4° C. The colder the water the more carbon dioxide can be introduced into the water (Henry's law) and the more efficiently the white ice cubes can be generated.

As illustrated in FIG. 1, the purified water downstream of a sterilisation unit, if operated as heating unit can, according to yet another preferred embodiment, be used to at least partially preheat the water supply of the heating unit. This pre-heating can be carried out in a counter flow direction, for example in that the water inlet supply tube of the heating unit is surrounded by a larger diameter hollow body, preferably in the form of a cocentrical cylindrical structure 80, in the inter space of which the heart, purified water downstream of said heating unit circulates counter to the flow in the supply tube prior to entering the cooling unit.

The cold, purified and carbonated water is then delivered to the ice-making unit 51 by use water pumps 37. Further water pumps 37′ and 37″ can be used for circulating water between the other components of the pre-module 1, i.e. between the water supply 3 and the heating unit 5 and between the heating unit 5 and the cooling unit 11.

The ice-making unit 51 comprises a freezing unit 53, a freezing tank 54 for storing cold, purified and carbonated water, a freezing element 59 and an ice storage compartment 67 in which the purified white ice prepared in the ice-making unit 51 is stored.

The freezing unit 53 is connected to a refrigeration circuit, which is preferably again a Clausius-Rankine cycle and functions as the heating/cooling circuit described above for the pre-module 1, using a circulating refrigeration fluid 81, a compressor 71′, a condenser 73′, a throttle valve 75′, an auxiliary circuit with a valve 35′ and a heat exchanger 79. The refrigeration fluid 81, 81′, 81″, 81′″ is compressed, heated, expanded and cooled in analogy to the circulation fluid 25, 25′, 25″, 25′″ described for the heating/cooling circuit of the pre-module 1. A refrigeration system using a refrigeration circuit is shown in U.S. Pat. No. 6,196,007. In that system, however, the compressor is located in a separate machine cabinet.

The freezing element 59 comprises several cooling fingers 60 of a conductive material, which are vertically oriented and spaced apart from each other. For the production of purified white ice, cold, purified and carbonated water is sprayed onto the cooling fingers 60 by a number of spray nozzles 58, which are arranged within the freezing unit 53 below the cooling fingers 60.

For energy saving purposes, the cold, purified and carbonated water from the pre-module 1 is delivered directly to the freezing unit 53 and thus to the spraying nozzles 58 without intermediate storing. The delivery of the water can be interrupted by means of an intermittent valve 62.

In summary, the preparation of purified white ice is in this embodiment achieved by delivering cold, purified and carbonated water from the pre-module 1 to the freezing unit 53 and spraying it onto the cooling fingers 60, which are cooled below 0° C.

Cooling of the fingers 60 is done by feeding cold liquid refrigeration fluid 81″ through a fluid line, which forms part of the heat exchanger 79 in the freezing unit 53 and channels through the freezing element 59 and the cooling fingers 60. The cold liquid refrigeration fluid 81″ has a temperature well below 0° C. and cools the cooling fingers 60 from the inside to the surface.

The cold, purified water to be sprayed onto the cooling fingers 60 has a temperature just above freezing point. This allows the water to freeze and stick to the cooling fingers 60 almost immediately. The ice preparation process is thereby not only sped up substantially, but also enables the production of very pure, very white ice.

The intermittent valve 62 interrupts the water delivery to the spraying nozzles 58 at predefined time intervals. Thereby, a predefined amount of cold, purified and carbonated water is sprayed onto the cooled cooling fingers 60 before the water supply is interrupted by the intermittent valve 62. Said predefined amount of water is adjusted such that essentially all water sprayed onto the cooling fingers 60 adheres to the surface of the latter and freezes instantly. Purified white ice cubes (or rather shaped ice objects, the expression ice cube is to be given a broad interpretation in this application including in particular also thick-walled thimble like ice objects formed on the fingers 60) are prepared by forming multiple layers of purified white ice on top of each other until ice of a predefined thickness has formed on the surface of the cooling fingers 60. Thus, essentially all cold, purified and carbonated water delivered by unit 1 is frozen to purified white ice and essentially no water needs to be discharged. Nevertheless, if there is some cold, purified and carbonated water that has not been transformed into purified white ice, it can be discharged through the water outlet 57 of the freezing tank 52 and fed through a water discharge pipe 43 to a water storage unit 45 arranged in the pre-module 1.

For the purpose of further energy saving, cold, purified and carbonated water from the pre-module 1 is preferably delivered directly to the freezing unit 53 and thus to the spraying nozzles 58 without intermediate storing.

If the ice layer formed around the cooling fingers 60 has reached a certain thickness, water delivery to the spraying nozzles 58 is stopped, and hot vaporised refrigeration fluid 81′ of high pressure is fed through the fluid line within the freezing element 59, thereby heating up the cooling fingers 60 and instantaneously de-icing the ice formed around the cooling fingers 60 such that the ice cubes drop down into the freezing tank 52 due to gravity. The delivery of the hot vaporised refrigeration fluid 81′ is controlled by the valve 35′, under control of the control unit 41.

When the hot vaporised refrigeration fluid 81′ of high pressure is introduced into the fluid line, the delivery of cold liquid refrigeration fluid 81″ is automatically stopped or at least remarkably reduced due to the pressure difference between the cold low pressure liquid refrigeration fluid 81″ and the hot vaporised refrigeration fluid 81′ of high pressure. When the de-icing is completed, the valve 35′ is closed and the hot vaporised refrigerant 81′ of high pressure in the fluid line is replaced by cold low pressure liquid refrigeration fluid 81″. The ice cubes that have dropped into the freezing tank are discharged through an ice outlet 61 from the freezing tank 52 and transferred to an ice storage compartment 67 or directly to an outlet opening of the device. Preferably, the ice storage compartment 67 is at least isolated, more preferably comprises a cooling element. It can for example be coupled to either of the two cooling cycles, or, in case only one single cooling cycle is used for cooling in unit 11 and 53, to this single cooling cycle. Then, cold, purified and carbonated water from the cooling unit 11 and/or the water storage unit 45, respectively, is delivered to the freezing unit 53, to the spraying nozzles 58 and a new ice formation cycle is started. The water storage unit 45 and the freezing tank 52 also comprise water level sensors (not shown) for sensing and controlling the water level in the water storage unit 45 and the freezing tank 52, respectively. The water level sensors are controlled by the control unit 41.

The control unit 41 is also suited for controlling the size of the ice formed. Preferably, the control unit 41 is used for preparing ice on demand, such that ice in a desired amount, shape, size and design is prepared upon entering a corresponding command.

While in the scheme illustrated in the figure of the water purification and cooling takes place in a pre-module 1 and the actual freezing takes place in an ice-making unit 51, this can also be combined within one single unit. In this case it is possible to use one single cooling circuit instead of two as illustrated in FIG. 1. So the same cooling circuit can be used for cooling the water in unit 11 and for freezing it in unit 53 as well as for at least pre-heating the water in the heater 5. In order to have optimum energy management, in this case the cooling liquid downstream of valve 75 of such a single unit is first used at a lower temperature for the freezing within freezing unit 53, and downstream thereof, at a temperature slightly above or around freezing point, for cooling in the unit 11. Like this only one single cooling circuit can be used for both cooling tasks in unit 11 and 53 under optimum conditions.

In addition to the units as illustrated in FIG. 18 also be provided a unit in which a colourant to colour the resultant ice cubes is added to the liquid. Preferably such a unit adds the corresponding colourant downstream of the heating unit 5 or in the cooling unit 11.

LIST OF REFERENCE SIGNS

| | |
|---|---|
| 1 | pre-module |
| 3 | water supply |
| 5 | sterilization unit/heating unit |
| 7 | water inlet of 5 |
| 8 | heating tank of 5 |
| 9 | hot water outlet |
| 11 | cooling unit |
| 12 | cooling tank of 11 |
| 13 | hot water and let off 11 |
| 15 | cold water outlet |
| 17 | carbonation unit |
| 19 | outlet for introducing carbon dioxide |
| 21 | water outlet |
| 25 | circulation fluid |
| 27 | heat exchanger |
| 29 | heat exchanger |
| 33 | dosage valve for carbon dioxide |
| 35 | valve |
| 37 | water pump |
| 39 | first valve |
| 41 | control unit |
| 43 | water discharge pipe |
| 45 | water storage unit |
| 49 | carbon dioxide supply tank |
| 51 | ice making unit |
| 53 | freezing unit |
| 54 | freezing tank |
| 59 | spray nozzles |
| 59 | freezing element |
| 60 | cooling fingers |
| 62 | valve |
| 67 | ice storage compartment |
| 71 | compressor |
| 73 | condenser |
| 75 | throttle valve |
| 79 | heat exchanger |
| 80 | larger diameter cocentrical tube |
| 81 | circulating refrigeration fluid |

1.-15. (canceled)

16. A purified ice unit for the preparation of purified ice cubes comprising the following components:
a connection for a water supply;
a sterilization unit with at least one water inlet connected to said water supply and at least one purified water outlet for discharging purified water,
a cooling unit comprising at least one water inlet to receive the water from the sterilization unit and at least one cold water outlet,
at least one freezing unit for the making of the purified ice cubes having at least one water inlet connected to said cold water outlet, a water discharge outlet and an ice outlet,
wherein said cooling unit and said freezing unit are separate units,
wherein said purified ice unit further comprises a carbonation unit comprising at least one outlet for introducing carbon dioxide into the cold, purified water downstream of the cooling unit so as to prepare cold and carbonated water upstream of the freezing unit, and
wherein carbon dioxide is introduced into the cold water at a temperature in the range of 3-5° C. to lead to a carbon dioxide concentration in the range of 0.05%-2 weight-%.

17. The purified ice unit according to claim 16, wherein said sterilization unit is working with heat sterilization, electromagnetic irradiation sterilization, or a combination thereof, wherein in case of heat sterilization the heat sterilization is controlled such that the water flowing through the sterilization unit is maintained at a temperature of at least 65° C. for a residence time span of at least 200 seconds within said sterilization unit, and
wherein in case of electromagnetic irradiation sterilization the water flowing through the sterilization unit is exposed to short wave UV irradiation in an amount sufficient to sterilize the water.

18. The purified ice unit according to claim 17, wherein in case of heat sterilisation said sterilisation unlit is controlled such that the water flowing through the sterilization unit is maintained at a temperature of at least 70° C., for a residence time span of at least 60 seconds, within said sterilization unit.

19. The purified ice unit according to claim 17, wherein in case of electromagnetic irradiation sterilisation the water flowing through the sterilization unit is exposed to UV radiation with a wavelength in the range of 300-100 nm.

20. The purified ice unit according to claim 16, wherein said sterilisation unit is a continuous or quasi-continuous flow-through heating unit.

21. The purified ice unit according to claim 16, wherein the purified water downstream of said sterilisation unit in the form of a heat sterilisation unit is used to at least partially preheat the water supply of the heat sterilisation unit, and/or
wherein the cooling unit and the sterilisation unit are connected to a heating/cooling circuit, said heating/cooling circuit involving a circulation fluid, which circulates between the cooling unit and the sterilisation unit through heat exchangers for transferring heat from the cooling unit to the sterilisation unit.

22. The purified ice unit according to claim 16, wherein the purified ice unit further comprises a water storage unit for storing discharged water from the freezing unit.

23. The purified ice unit according to claim 16, wherein the freezing unit comprises at least one freezing element, which is in a form of one or more cooling fingers and/or moulds and/or a lattice or an ice extruder, wherein the at least one freezing element can be cooled for producing ice and heated for discharging the ice from the freezing element.

24. The purified ice unit according to claim 16, wherein the freezing unit further comprises at least one spraying nozzle for spraying the cold, purified and carbonated water onto a freezing element.

25. A method for preparing purified ice, using a purified ice unit according to claim 16, wherein upstream of said at least one freezing unit for the making of the purified ice cubes the supplied water is cooled in said cooling unit, and
wherein further said carbonation unit is provided comprising at least one outlet for introducing carbon dioxide into the cold, purified water downstream of and/or in the cooling unit preparing cold, purified and carbonated water upstream of the freezing unit.

26. The method according to claim 25, wherein upstream of said cooling unit the supplied water is sterilised in a sterilisation unit working with heat sterilization, electromagnetic irradiation sterilization, or a combination thereof, integrated in the same unit,
wherein in case of heat sterilisation said sterilisation unit is a heat sterilisation unit and is controlled such that the water flowing through the heat sterilisation unit is maintained at a temperature of at least 65° C. for a residence time span of at least 200 seconds within said heat sterilisation unit,
wherein the heat sterilization unit is a continuous or quasi-continuous flow-through heat sterilisation unit, and
wherein in case of electromagnetic irradiation sterilisation, the water flowing through the heat sterilisation unit is exposed to short wave UV irradiation in an amount sufficient to sterilize the water.

27. The method according to claim 26, wherein in case of heat sterilisation, said heat sterilisation unit is controlled such that the water flowing through the heat sterilisation unit is maintained at a temperature of at least 70° C., for a residence time span of at least 60 seconds, within said heat sterilisation unit, and/or
wherein in case of electromagnetic irradiation sterilization, the water flowing through the heat sterilisation unit is exposed to UV radiation with a wavelength in the range of 300-100 nm.

28. An ice cube made using a method according to claim 25.

29. The purified ice unit according to claim 16, wherein carbon dioxide is introduced into the cold water to lead to a carbon dioxide concentration the range of 0.1-2 weight-%, at a temperature of the cold water in the range of 3-4° C.

30. The purified ice unit according to claim 17, wherein in case of heat sterilisation said sterilisation unit is controlled such that the water flowing through the sterilisation unit is maintained at a temperature of at least 98° C. or at least 110° C. for a residence time span of at least 5 seconds, or at least 2 seconds within said sterilisation unit.

31. The purified ice unit according to claim 17, wherein in case of electromagnetic irradiation sterilisation the water flowing through the purified ice unit is exposed to UV radiation with a wavelength in the range of 250-260 nm, with a dose in the range of 15-50 mWs/cm², and
wherein for the irradiation mercury vapour ultraviolet lamps are used, including low pressure lamps.

32. The purified ice unit according to claim 16, wherein the purified water downstream of said sterilisation unit in case of heat sterilisation is used to at least partially preheat the water supply of the sterilisation unit, wherein this pre-heating is carried out in a counter flow direction, in that the water inlet supply tube of the sterilisation unit is surrounded by a larger diameter hollow body, in the form of a cocentrical cylindrical structure, in the inter space of which the purified water downstream of said sterilisation unit circulates counter to the flow in the supply tube prior to entering the cooling unit.

33. The purified ice unit according to claim 16, wherein the purified ice unit further comprises a water storage unit for storing discharged water from the freezing unit, wherein the water storage unit comprises a water storage outlet, which is connected to the water inlet of the freezing unit for re-introducing the stored cold, purified and carbonated water into the freezing unit of the ice-making unit.

34. The purified ice unit according to claim 16, wherein the freezing unit further comprises at least one spraying nozzle for spraying the cold, purified and carbonated water onto a freezing element, and also an intermittent valve for interrupting the delivery of cold, purified and carbonated water to the spraying nozzle at predefined time intervals.

35. The method according to claim 25, wherein carbon dioxide is introduced into the cold purified water to lead to a carbon dioxide concentration the range of 0.1-2 weight-%.

36. The method according to claim 25, wherein carbon dioxide is introduced into the cold purified water to lead to a carbon dioxide concentration the range of 0.1-2 weight-%, at a temperature of the cold water in the range of 3-4° C.

37. The method according to claim 26, wherein in case of heat sterilisation said heating sterilization unit is controlled such that the water flowing through the heat sterilization unit is maintained at a temperature of at least 98° C. or at least 110° C. for a residence time span of at least 5 seconds, or at least 2 seconds within said heat sterilization unit, and/or
wherein in case of electromagnetic irradiation sterilisation the water flowing through the sterilisation unit is exposed to UV radiation with a wavelength in the range of 250-260 nm, with a dose in the range of 15-50 mWs/cm², and wherein for the irradiation mercury vapour ultraviolet lamps are used, including low pressure lamps.

38. An ice cube made using a unit for the preparation of purified ice cubes according to claim 16.
